(19) United States
(12) Patent Application Publication
(10) Pub. No.: US 2014/0074648 A1
(43) Pub. Date: Mar. 13, 2014

(54) PORTION RECOMMENDATION FOR ELECTRONIC BOOKS

(71) Applicants: Michael Salomon Morton, Lyme, NH (US); Jeremy Faller, Arlington, MA (US)

(72) Inventors: Michael Salomon Morton, Lyme, NH (US); Jeremy Faller, Arlington, MA (US)

(73) Assignee: Google Inc., Mountain View, CA (US)

(21) Appl. No.: 13/610,236

(22) Filed: Sep. 11, 2012

(51) Int. Cl. G06Q 30/00

(52) U.S. Cl. 705/26.7

(57) ABSTRACT

A method for providing comments for an electronic book with a number of portions includes receiving user tags, each corresponding to a portion; analyzing the tags to generate corresponding reader-specific information; and preparing presentation information based on the reader-specific information. A reader can create such comments for the reader's own later use or a group of readers can generate comments that are presented to yet another reader at a later time.

### TECHNICAL FIELD

The disclosure relates generally to the field of electronic media, and specifically to recommending portions of electronic books.

### BACKGROUND

Existing Internet stores such as the GOOGLE PLAY STORE™ make recommendations to users regarding media objects such as books, movies, and games. Such recommendations are ordinarily based on media objects a user has previously accessed in some manner (e.g., by making a purchase, a rental, or the like) and media objects accessed by other users with similar access histories to the user.

Traditionally, feedback on such media objects has been provided by expert reviewers. With the growth of the Internet, “crowd sourced” feedback has become increasingly popular. Typical crowd sourcing of feedback entails users (rather than professional reviewers) entering ratings and reviews into a feedback collection system. For example, the GOOGLE PLAY STORE™ enables users to rate a book with a score from one to five and provide a written review. These ratings and reviews are aggregated and made available to other users to inform their decisions regarding whether to purchase a particular book.

When considering recommended reference materials, users are often hesitant to invest money and time into unknown materials. Existing recommendation systems do not take into account the skill and knowledge levels of users; therefore it is hard for a user to be confident that a recommended book will be personally relevant to the user. Further, the user has to review the entire book to determine which portions of the book are useful to the user.

### SUMMARY

The above and other issues are addressed by a computer-implemented method, non-transitory computer readable storage medium, and computer system for recommending portions of electronic books.

In one aspect, a method for providing comments includes receiving a number of user tags, each corresponding to a portion of an electronic book; analyzing the tags to generate reader-specific information corresponding to the portions; and preparing presentation information for presentation at a client device, the presentation information being based on the reader-specific information.

In a related aspect, the user tags are created by a first reader and the presentation information is intended for that reader. In a different aspect, the user tags are created by a first subset of readers and the presentation information is intended for a different subset of readers. In another related aspect, the first subset of readers is selected based on an affinity with the second subset; the affinity is in some instances a common knowledge level or common interest. In some aspects, the presentation information includes an indication of usefulness of a portion, a reference in a social network to a corresponding portion, and a recommendation to a corresponding portion.

Related computer systems and components implementing such methods are also disclosed herein.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a high-level block diagram illustrating a networked computing environment, consistent with one embodiment.

FIG. 2 is a high-level block diagram illustrating an example of a computer for use in the computing environment shown in FIG. 1.

FIG. 3 is a high-level block diagram illustrating a client device suitable for use in the networked computing environment shown in FIG. 1, according to one embodiment.

FIG. 4 is a high-level block diagram illustrating the recommendation subsystem of the cloud provider facility of FIG. 1, according to one embodiment.

FIG. 5 is a flowchart illustrating a method for providing electronic book recommendations, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### System Overview

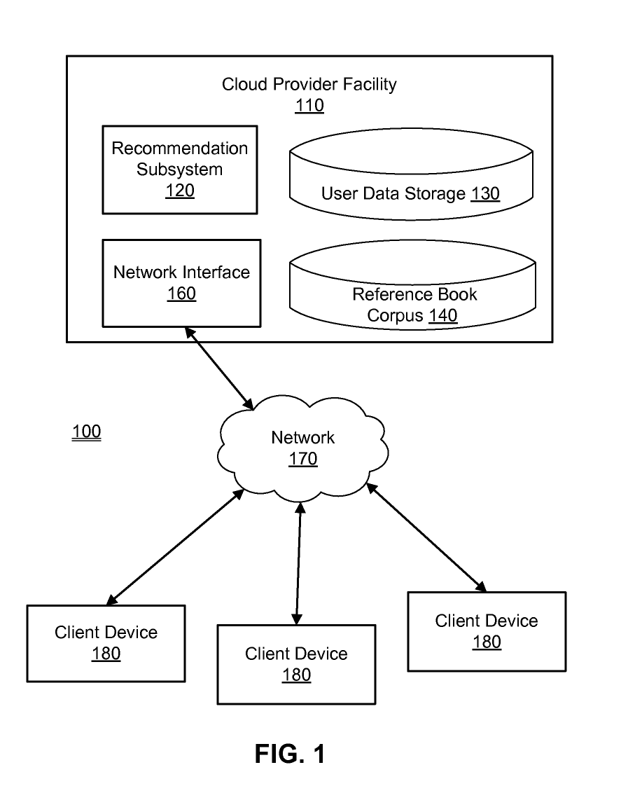

It would be advantageous to readers if a recommendation system not only recommended entire reference books, but also provided recommendations regarding specific portions of reference books. It would also be advantageous if such a recommendation system leveraged the crowd sourced feedback paradigm to improve the relevance of recommendations made. FIG. 1 shows a networked computing environment 100 for addressing this need by providing portion recommendations for electronic books, consistent with one embodiment. The networked computing environment 100 includes a cloud provider facility 110 and a plurality of client devices 180, of which three are shown for exemplary purposes only. The client devices 180 and cloud provider facility are connected by a network 170.

The cloud provider facility 110 makes available for purchase, licensing, rental or subscription books that can be viewed on the client devices 180. In addition, the cloud provider facility 110 collects and analyzes feedback to provide recommendations to users regarding both full books and individual sections of those books (e.g., chapters, pages, paragraphs, and the like).

The network 170 is typically the Internet, but can be any network, including but not limited to any combination of a LAN, a MAN, a WAN, a mobile, a wired or wireless network, a private network, or a virtual private network. The cloud provider facility 110 is connected to the network 170 through a network interface 160.

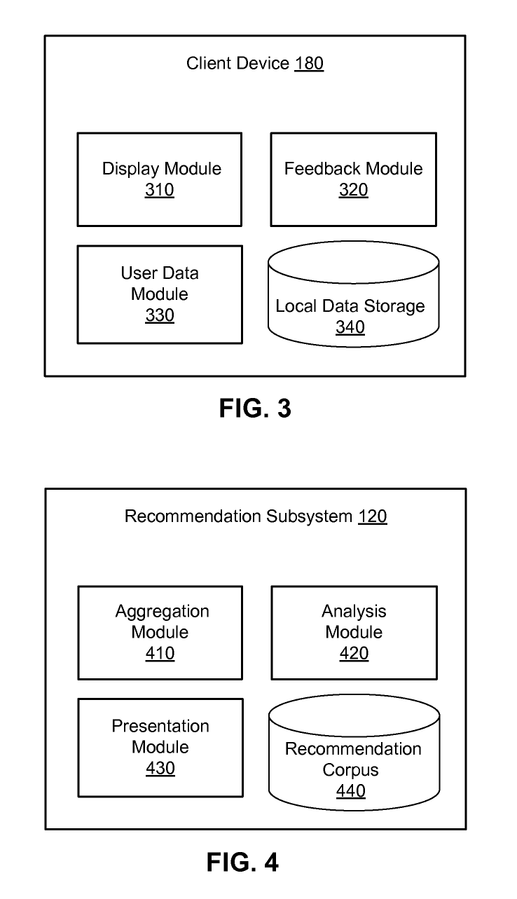

The client devices 180 can be any computing device or other electronic device capable of displaying an electronic book to a user, such as desktop PCs, laptops, smartphones, PDAs, electronic book readers, and the like. As discussed above, although only three client devices 180 are shown, in practice there are many (e.g., millions of) client devices 180 that can communicate with the cloud provider facility 110 using the network 170. An exemplary client device is described in greater detail below with reference to FIG. 3.

In the illustrated embodiment, the cloud provider facility 110 includes a recommendation subsystem 120, a network interface 160, user data storage 130 and a literature corpus 140. The network interface 160 enables the various components of the cloud provider facility 110 to communicate with each other internally, as well as with the client devices 180 via the network 170. Other embodiments of the cloud provider facility 110 include different and/or additional components. In addition, the functions may be distributed among the components in a different manner than described herein.

The literature corpus 140 comprises one or more data storage devices that hold a collection of electronic books that are available for access from client devices 180, or that otherwise stores content related to such a collection of electronic books. Modern electronic books are not limited to mere collections of digital text. Electronic books comprise many different combinations of text, images, music, sound effects, video, interactive features, and the like. As used herein, the term electronic book should be taken to encompass all forms of media object that may be used as reference material. Those skilled in the art will recognize that other media objects, such as videos and audio streams can also be processed in accordance with the teachings herein.

In some embodiments, metadata is embedded in all or some of the electronic books. The term metadata is used herein to encompass all data corresponding to a book that is available in the computing environment 100. In one embodiment, users provide recommendations regarding portions of traditional paper books and recommendations are presented to other users along with an option to purchase either a paper or electronic copy of recommended books and/or portions thereof.

The user data storage 130 comprises one or more data storage devices (which may be the same devices that make up the literature corpus 140) that hold information about user accounts. Typically, when a user wishes to access the services provided by the cloud provider facility 110 the user will log into the cloud provider facility by providing authentication data (for example a username and password) that are verified against user records stored in the user data storage 130.

In some embodiments, the user data storage 130 also contains data about reading histories associated with user accounts, such as a list of books read and a current position in one or more books that the user is yet to complete. The storage of current positions as part of user account data enables, amongst other things, users to pick up reading at the point they last stopped, even if they are using a different client device 180. In one such embodiment, the user data storage 130 also contains profile information for the user, such as age, profession, job title, experience level, skills, and interests. In one embodiment, users are asked for their consent to allow the collection of usage data and, in that embodiment, given a user interface control to let them opt out of such collection.

The recommendation subsystem 120 is configured to manage collection and dissemination of recommendation information corresponding to the electronic books contained in literature corpus 140. In one mode of operation, the recommendation subsystem 120 provides a user interface by which users who are reading or have read a work can input information regarding how helpful, clear, well-written, timely, etc. a particular portion of a work has been. For example, when someone reading a book on client device 180 finishes a chapter, that person can be prompted to complete a very brief survey corresponding to the perceived value of that chapter. In a second mode of operation, the recommendation subsystem 120 provides a user interface by which users who might be interested in purchasing or otherwise accessing the work can see portion-by-portion recommendations regarding the work. This is particularly helpful in connection with an electronic book store application (as referenced above) that allows users to obtain not only full books, but select individual portions of books as well. The recommendation subsystem 120 is described in greater detail below, with reference to FIGS. 3 and 4.

### Computing System Architecture

The entities shown in FIG. 1 are implemented using one or more computers.

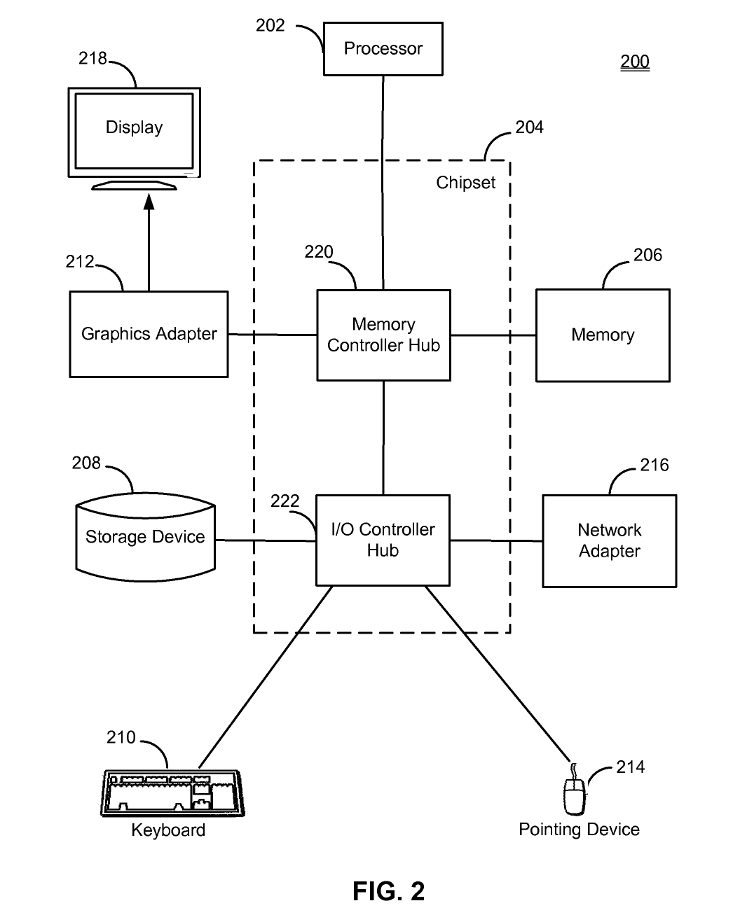

FIG. 2 is a high-level block diagram illustrating an example computer 200. The computer 200 includes at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display 218 is coupled to the graphics adapter 212. A storage device 208, keyboard 210, pointing device 214, and network adapter 216 are coupled to the I/O controller hub 222. Other embodiments of the computer 200 have different architectures.

The storage device 208 is a non-transitory computer-readable storage medium such as a hard drive, compact disk read-only memory (CD-ROM), DVD, or a solid-state memory device. The memory 306 holds instructions and data used by the processor 202. The pointing device 214 is a mouse, track ball, or other type of pointing device, and is used in combination with the keyboard 210 to input data into the computer system 200. The graphics adapter 212 displays images and other information on the display 218. The network adapter 216 couples the computer system 200 to one or more computer networks.

The computer 200 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 208, loaded into the memory 206, and executed by the processor 202.

The types of computers used by the entities of FIG. 1 can vary depending upon the embodiment and the processing power required by the entity. For example, the cloud provider facility 110 might comprise multiple blade servers working together to provide the functionality described herein, whereas client devices 180 might be tablet computing devices. The computers can lack some of the components described above, such as keyboards 210, graphics adapters 212, and displays 218.

### System Details

FIG. 3 is a high-level block diagram illustrating a client device 180 suitable for presenting an electronic book and portion recommendations to a user, according to one embodiment. The client device shown includes a display module 310, a feedback module 320, a user data module 330, and local data storage 340. Other embodiments of client devices 180 include different and/or additional modules. In addition, the functions may be distributed among the modules in a different manner than described herein.

The display module 310 receives at least part of an electronic book and presents it to the user on a screen. Alternatively, the display module 310 presents the electronic book in audio form using either text to speech or a pre-recorded narration. In one embodiment, the user has pre-downloaded the electronic book from the cloud provider facility 110 (e.g., by purchasing the electronic book from GOOGLE PLAY STORE™) and the display module 310 accesses the electronic book from local data storage 340. In another embodiment, the display module 310 directly accesses a remote copy of the book stored in the literature corpus 140 via the network 170.

The feedback module 320 collects feedback from the user regarding the electronic book currently being displayed by the display module 310. Depending on the embodiment, feedback is either stored in local data storage 340, immediately sent to the cloud provider facility 110 and stored in user data storage 130, or initially stored in local data storage 340 before being processed and sent to cloud provider facility 100 by the feedback module 320 as part of a batch upload. For example, in one embodiment the feedback module 320 compiles user feedback regarding sections of a book and only uploads the feedback to the cloud provider facility 110 once the user has completed the entire book.

In one embodiment, the display module 310 presents user controls concurrently with the electronic book to passively solicit feedback from the user, for example by showing “like” and “dislike” buttons in a bottom portion of the display of the book reader. In another embodiment, the display module 310 actively solicits feedback from the user by asking for a rating for the chapter of the electronic book that the user has just read before displaying the next chapter.

The user data module 330 collects and processes data relating to the user obtained from at least one of: user input, local data storage 340, and the cloud provider facility 110. In one embodiment, the user data module 330 stores the user's current position in the electronic book. This data is useful both to enable the display module 310 to automatically open the electronic book to the user's current position at the start of a reading session, and to enable the display module 310 to display position specific feedback information to the user. In another embodiment, the user data module 330 also collects information about the user (e.g., job title and experience level) for use in processing feedback collected by the feedback module 320. The use of user data is described in greater detail below with reference to FIG. 4.

FIG. 4 is a high-level block diagram illustrating the recommendation subsystem 120 of the cloud provider facility 110, according to one embodiment. In the embodiment shown, the recommendation subsystem 120 comprises an aggregation module 410, an analysis module 420, a presentation module 430, and a recommendation corpus 440. Other embodiments of the recommendation subsystem 120 include different and/or additional modules. In addition, the functions may be distributed among the modules in a different manner than described herein.

The recommendation corpus 440 comprises one or more data storage devices that hold feedback that has been provided by users via the client devices 180. The recommendation corpus 440 may also comprise supplementary feedback provided by system administrators and/or expert reviewers.

The aggregation module 410 collects feedback that has been provided at the client devices 180 and stores it in the recommendation corpus 440.

In one embodiment, a client device 180 immediately pushes new feedback information to the recommendation subsystem 120 after it is collected by the feedback module 320 of the client device. In a related embodiment, the client device 180 only pushes new feedback data if more than a threshold amount of time (e.g., 5 minutes) has passed since the client device last pushed feedback data. The use of a threshold time prevents the network 170 from being flooded with data packets by a client device 180 that is collecting a large amount of feedback data. In other embodiments, the aggregation module 410 polls the client devices 180 at specific times (e.g., when a user logs in, or if more than a threshold period has elapsed since a previous update) for any new feedback (e.g., stored in local data storage 340) that has not yet been added to the recommendation corpus 440.

The analysis module 420 analyzes the data in the recommendation corpus 440 to provide context for the feedback. As one example, consider a user who finishes a chapter in a technical book and provides feedback indicating that the chapter was too simplistic to be helpful. In one embodiment, analysis module 420 combines such data with data from the user's profile (e.g., stored in user data module 330). Over time, aggregation module 410 collects such combined data and analysis module 420 is able to determine that, for instance, users with a high school education typically find the chapter helpful, while those with a college degree in engineering universally find the chapter to be too simplistic. A particular reader, then, is able to get helpful comments based on affinities (e.g., common backgrounds) with others who have provided comments on the book.

The presentation module 430 prepares the data generated by the analysis module 420 for presentation at a client device 180. In one embodiment following the example discussed above, the presentation module 430 prepares a recommendation for a client device that states, “Those with a high school education typically find this chapter helpful, while those with a college education in engineering find it too simplistic to be helpful.” In another embodiment, a particular user's own profile information is used by the presentation module 430 to craft a more specific message, such as (to a high school student), “Those with an educational background similar to yours find this chapter helpful.” In still another embodiment, historical analysis of user feedback is used rather than affinities to derive similar correlations between users. For example, if one user marks a number of chapters in five books with “I didn't know that” tags, and a second user tags four books in much the same way, it is likely the second user would also tag the fifth book similarly. Those skilled in the art will recognize other possible ways to determine similarities among users.

### Exemplary Method

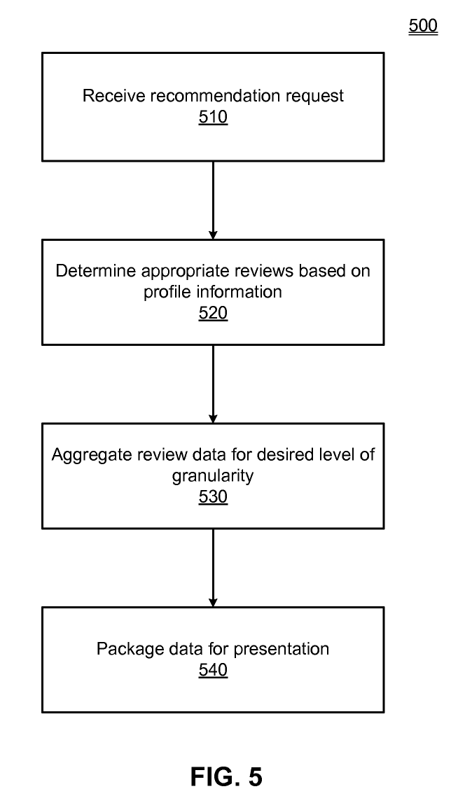

Turning now to FIG. 5, a flowchart is shown illustrating a method 500 for generating fine-grained recommendations, according to one embodiment. FIG. 5 attributes the steps of the method to the cloud provider facility 110. However, some or all of the steps may be performed by other entities. In addition, some embodiments may perform the steps in parallel, perform the steps in different orders, or perform different steps.

At step 510, cloud provider facility receives a request for feedback, which may be one or more recommendations. In one embodiment, such requests are generated when a user of a client device 180 expresses interest in a particular electronic book within the reference book corpus 140. For example, a user may be browsing among various books that are available from the GOOGLE PLAY STORE™ and may select one that looks interesting. In one embodiment, the next step, 520, involves comparing profile information of the person expressing interest in the book with the reviews stored in recommendation corpus 440. Following the example previously presented, if the person expressing interest is a high school student, reviews from others who are also high school students (rather than college professors, for example) are selected as being the most appropriate to use. In other embodiments, more detailed profile information is compared between the interested person and the persons who have provided reviews. For example, reviews of various chapters of a textbook on integral calculus may have been provided by those who have already taken a general introductory calculus course and by those who have, in addition to a general introductory course, taken a course specific to differential calculus. Further, if the person interested in the book happens to be a college student who is a biology major, it may be inappropriate to include chapter reviews from those who are graduate students in the department of mathematics. Those skilled in the art will recognize a number of factors that may be used to filter reviews from the recommendation corpus 440 to provide to any particular person expressing interest in a specific book. For instance, if someone with a user profile indicating a SCUBA diving affinity is interested in a book about sharks, it may be appropriate to filter reviews to favor those from others who share that affinity. In this regard, some embodiments may also allow users to indicate which aspects of their profile are relevant to their commentary (indicating that SCUBA diving is, but some other affinity such as cooking, is not). In some embodiments, no such filtering is undertaken, and all reviews in the recommendation corpus 440 for the book are retrieved.

Either way, in step 530, the available review information is aggregated at a level of granularity appropriate for the specific circumstance. For example, if the user is looking to purchase a textbook in its entirety, the review information may be aggregated at a chapter-by-chapter level of granularity. However, if the user is simply interested in purchasing a single academic paper in an electronic book that is a compilation of such papers (such as the proceedings from a technical conference), then the reviews may be provided on a section-by-section basis for the specific paper being considered.

Finally, in step 540, the review information is packaged into the form of a message that is appropriate for the purpose desired. In one embodiment, statistical methods are used to convert review data into a form that is most helpful for the end user. To give one example, consider as a simplistic example an integral calculus textbook with five chapters and the following review data:

| Chapter # | Title | Thumbs-up | Thumbs-down | Free-text comments |
|---|---|---|---|---|
| 1 | Introduction and | 3 | 7 | If you are picking up |
| | Overview | | | this book, you already |
| | | | | know everything in |
| | | | | this introductory |
| | | | | chapter. |
| | | | | — |
| | | | | Nice explanation of |
| | | | | the context of the |
| | | | | subject. |
| 2 | Area Under the Curve | 2 | 8 | Too basic!! We |
| | | | | already know this. |
| | | | | — |
| | | | | Didn't we all know |
| | | | | what this was from AP |
| | | | | Calc in high school? |
| | | | | — |
| | | | | No benefit from this |
| | | | | basic review of |
| | | | | fundamentals. |
| 3 | Integration by | 9 | 1 | Very clear explanation |
| | Substitution | | | of how to break down |
| | | | | hard problems into |
| | | | | easier ones. |
| | | | | — |
| | | | | For many problems, |
| | | | | includes multiple |
| | | | | methods of easily |
| | | | | solving the problems |
| | | | | so you can pick and |
| | | | | choose what seems |
| | | | | easiest for you. |
| | | | | — |
| | | | | The discussion of |
| | | | | substitution really |
| | | | | makes it easier to |
| | | | | understand the |
| | | | | concepts and gives |
| | | | | you a “feel” for what |
| | | | | the right answer |
| | | | | should look like. |
| 4 | Integration of | 5 | 5 | It is best just to skim |
| | Common Functions | | | this chapter at first and |
| | | | | then use it as a |
| | | | | reference if you run |
| | | | | across any of these |
| | | | | functions. |
| | | | | — |
| | | | | I was hoping that this |
| | | | | book would be more |
| | | | | comprehensive and |
| | | | | include far more |
| | | | | functions here than it |
| | | | | does. Not very |
| | | | | helpful for practical |
| | | | | use since there are |
| | | | | only about a dozen |
| | | | | functions addressed |
| | | | | here. |
| 5 | Applications | 9 | 1 | It is clear that the |
| | | | | author is not just a |
| | | | | mathematician, but an |
| | | | | applied |
| | | | | mathematician. If |
| | | | | you read any part of |
| | | | | this book, read this |
| | | | | chapter, as it is so |
| | | | | much more helpful |
| | | | | than what precedes it! |
| | | | | — |
| | | | | Wow, the professor |
| | | | | really breathes life into |
| | | | | what I thought was a |
| | | | | pretty abstract topic |
| | | | | here. I had no idea |
| | | | | you could do so much |
| | | | | using integral calculus |
| | | | | techniques. |
| | | | | — |
| | | | | Finally, I understand |
| | | | | why it's important to |
| | | | | study calculus! Nice |
| | | | | work in explaining |
| | | | | how calculus is |
| | | | | actually used in the |
| | | | | real world. READ |
| | | | | THIS CHAPTER! |

In some embodiments, a content provider provides parameters allowing reviewers to include short quotes from the book (e.g., limiting portions of the book from which quotes can be taken, limiting the length of quotes).

In one embodiment, step 510 includes merely presenting such a table to the user via a user interface portion, for example a “review” section in the GOOGLE PLAY STORE™ application running on client device 180. In another embodiment, such information can be summarized and presented in a more compact manner, such as, “Readers of this book particularly liked Chapters 3 and 5. Click HERE to see chapter-specific reviews.”

In another embodiment, reviews are generated not so much for the benefit of other readers, but rather for future reference by the reviewer. In such an embodiment, a reader's reviews are intended to remind a reader about certain information to allow the reader to be more efficient in accessing the material again. For instance, a student might finish a chapter and generate a review for that chapter that reads, “Don't bother studying this chapter—it's easy stuff and I can recreate the formulas even if I don't remember them.” Or, in a reference book for a product such as a computer or an automobile, a user might generate a review reading, “Don't bother looking at this section again—It only applies to the European version, not the American one.” In such an embodiment, the feedback module 120 is configured to include an “irrelevant” or “ignore” user interface button to tag a chapter as one that need not be consulted again. In a related embodiment such tagged chapters are automatically hidden from view or otherwise elided so as to keep display of the book limited to only portions of interest to the reader. A “re-read” button is included in some embodiments to allow users to tag difficult chapters that need to be revisited. Depending on the application and environment, other tags such as “I already know this” and “useful” are also available as user interface controls. Whenever the user refers to the book, the previous tags appear as reminders. In some embodiments, tags such as “I knew that” and “I didn't know that” are not static, but degrade in importance over time, since people typically forget information over time and also learn new information over time. Thus, actions based on threshold levels of tagging are in these implementations also influenced by the passage of time. Those skilled in the art will recognize other controls that may be provided to help readers in various fields of study and environments (e.g., college settings may call for a slightly different set of user interface controls than industry settings). In one embodiment, the user is given an option to share such tags with other users, and to control the amount of tag information, as well as the amount of profile information, the user would like to share.

In a related embodiment, chapters are tagged automatically based on the amount of time the user spends on the chapters. For instance, chapters that are skipped over or only very briefly reviewed are inferred to have less value to the reader than those that are pored over for long periods of time.

In yet another embodiment, chapter-specific feedback and review information propagate to other applications. As an example, if a book chapter explains an experiment that helps to illustrate a scientific principle, a user interface feedback control adds the chapter to the user's “to-do” list via the user's productivity application. Similarly, some book sections are useful only once, while others are useful repeatedly (e.g., glossary sections). Some books have temporal aspects that integrate, in corresponding embodiments, with calendar applications. Integration with calendar applications is also useful in environments in which the user's interaction with a book has an important time component, e.g., length of time to complete reading of a book is based not just on how many pages remain, but how long it has taken other reviews to complete certain chapters (tagged as “short”, for instance) as opposed to others (tagged as “long”). Again, these tags can be added as appropriate, and propagate as desired to other applications besides a calendar application, such as browser bookmarks, address books, shopping lists, RSS feeds, social networking applications and the like. In one specific embodiment, reviewers are introduced to one another based on the content of their reviews, the skill levels evident from their profiles, their geographic proximity, etc.

In still another embodiment, chapter-specific recommendations are filtered based on additional criteria. For example, for a popular book with thousands of reviews, only reviews provided by those in any of the user's social networks, address books, etc. (collectively the user's “social graph”) are provided to the user. As an alternative, ratings from within the user's social graph carry more weight than those outside the graph, so that for instance if only a subset of free-text comments are provided, it is more likely that comments from within the user's social graph are provided than other comments. Weightings are, in various embodiments, made based on other factors as well, such as whether a reviewer was reading a paid-for complete edition of the book or merely a free excerpt. In a related embodiment, after a user purchases a book, recommendations and comments from those in the user's social graph are automatically presented with the book.

In still another related embodiment, a user's own past chapter specific reviews and tagging are applied from other books to provide an estimate of how likely the user will find a new book useful. For example, if a user has highly rated other books with chapters that, on average, other users have rated as “very difficult” and poorly rated books that have chapters often rated as “simplistic”, this information is used to generate an estimate of how likely the user is to find a new book useful. An appropriate user interface message such as, “Several chapters in this book have been rated as ‘highly technical’ by others, and in the past you have indicated you like books that have chapters rated as ‘highly technical.’” Furthermore, excerpts from such chapters most likely to be of interest (here, the highly technical chapters) are provided in one embodiment for the user to review before making a purchasing decision.

In another application, when a user purchases a book, the chapters are tagged with nominal ratings based on feedback provided by others. As the user reads the book, the user may choose to change those tags to be personal. For instance, an initial tag of “Others think this is useless” can be changed to “I think this is relevant and helpful.” Where tags have only two states (e.g., thumbs up or down), a simple user interface “confirm/reverse” control permits the user to efficiently indicate agreement or disagreement with the nominal tagging that is initially provided.

Providers of such electronic books may see such features as a way to drive sales, and accordingly in one embodiment user interface features provide rewards to users for providing feedback and comments. Such rewards range in various embodiments from symbolic “way to go!” messages to financial incentives such as discounts and credits. Individual reviewers are in some embodiments also, over time, determined to be “reliable” or not based on how many subsequent readers agree or disagree with their feedback, and in some embodiments further incentives are provided to those who are found to be particularly good reviewers. Such reviewers may also be rewarded by getting partial refunds for segments tagged as unhelpful (e.g., “simplistic”, “not relevant”, “I knew that”), typically up to some limit established by, for example, the corresponding publisher. Presumably, such feedback can be quite helpful to publishers in producing future, more relevant and useful books. Further, correlations among tagged portions may help publishers make decisions about future content (e.g., if nearly everyone who marks chapter 1 as “too basic” also marks chapter 3 the same way, perhaps those two chapters deserve to form the basis of an introductory book and the remaining chapters should be kept as an advanced book).

While the bulk of discussion here has centered on chapter-based feedback, other portions of a book can be selected for feedback as well. In some instances, granularity may be as broad as an entire volume in a multi-volume treatise, while in other instances it may be as small as a single sentence. Appropriate delimiters are provided in such embodiments to allow readers to indicate the portion of the work to which they intend the feedback to apply. Those skilled in the art will recognize other techniques may be applied as well, for instance inferring a portion based on user actions, such that user selection of a few words of text followed by a command to enter feedback is interpreted as applying to a single sentence, while user entry of feedback at the end of a chapter is interpreted as applying to the entire chapter.

The systems and methods herein can also be readily applied to books that are presented in various languages, with metadata establishing correspondences between portions in version of the book and those in another. The systems and methods herein can also be applied to content that evolves over time, such as a corpus of newsgroup postings. Those skilled in the art will readily recognize application of the teachings here to content other than static electronic book content.

### Additional Considerations

In this description, the term “module” refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent one embodiment of the present invention, and other embodiments may include other modules. In addition, other embodiments may lack modules described herein and/or distribute the described functionality among the modules in a different manner. Additionally, the functionalities attributed to more than one module can be incorporated into a single module.

In an embodiment where the modules as implemented by software, they are stored on a computer readable persistent storage device (e.g., hard disk), loaded into the memory, and executed by one or more processors included as part of a client device 180 and/or cloud provider facility 110. Alternatively, hardware or software modules may be stored elsewhere within the networked computing environment 100. The networked computing environment 100 includes hardware elements necessary for the operations described here, including one or more processors, high speed memory, hard disk storage and backup, network interfaces and protocols, input devices for data entry, and output devices for display, printing, or other presentations of data.

Numerous variations from the system architecture of the illustrated computing environment 100 are possible. The components of the environment 100 and their respective functionalities can be combined or redistributed. For example, the reference book corpus 140 can be distributed among any number of physical devices.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for providing portion-by-portion comments to electronic books. Thus, while particular embodiments and applications have been illustrated and described, it is to be understood that the present disclosure is not limited to the precise construction and components disclosed herein and that various modifications, changes and variations which will be apparent to those skilled in the art may be made in the arrangement, operation and details of the method, system, and storage medium disclosed herein without departing from the spirit and scope as defined in the appended claims.

1. A computer-implemented method for providing comments for an electronic book having a plurality of portions, the method comprising:
receiving, at a processor, a plurality of user tags, each of the user tags corresponding to one of the plurality of portions;
analyzing, by a processor, the user tags to generate reader-specific information corresponding to the plurality of portions; and
preparing presentation information for presentation at a client device, the presentation information being based on the reader-specific information.

2. The method of claim 1, wherein the user tags are created by a first reader and wherein the presentation information is intended for the first reader.

3. The method of claim 1, wherein the user tags are created by a first subset of readers and wherein the presentation information is intended for a second subset of readers, the first and second subsets of readers being disjoint.

4. The method of claim 1, wherein the analyzing comprises collecting a subset of the user tags corresponding to a first subset of readers and the reader-specific information corresponds to a second subset of readers, the first subset of readers being selected responsive to an affinity with the second subset of readers.

5. The method of claim 4, wherein the affinity relates to a knowledge level.

6. The method of claim 4, wherein the affinity relates to an interest.

7. The method of claim 1, wherein the analyzing comprises:
receiving, from a database, first feedback created by a first reader, the first feedback corresponding to a reference, wherein the reference is not the electronic book;
receiving, from the database, second feedback created by a second reader, the second feedback corresponding to the reference, wherein the second reader also created the plurality of user tags;
identifying a correlation between the first reader and the second reader responsive to correspondence between the first and second feedback; and
generating the reader-specific information based on a second plurality of user tags created by the first reader, each of the user tags in the second plurality corresponding to one of the plurality of portions of the electronic book, wherein the reader-specific information corresponds to the second reader.

8. The method of claim 1, wherein the presentation information includes an indication of usefulness of a corresponding one of the plurality of portions.

9. The method of claim 1, wherein the presentation information includes a reference in a social network to a corresponding one of the plurality of portions.

10. The method of claim 1, wherein the presentation material includes a recommendation to a corresponding one of the plurality of portions.

11. A computer system for commenting on an electronic book comprising a plurality of portions, the system comprising:
a display;
a display module configured to present the electronic book on the display; and
a feedback module operably connected to the display module and the user data module, the feedback module configured to (a) collect a plurality of reader-specific tags; (b) determine, for each reader-specific tag, a corresponding one of the plurality of portions and (c) send data corresponding to the tag and the corresponding one of the plurality of portions to a recommendation subsystem for processing to generate presentation information therefrom.

12. The system of claim 11, wherein the reader-specific tags are created by a first reader and wherein the presentation information is intended for the first reader.

13. The system of claim 11, wherein the reader-specific tags are created by a first subset of readers and wherein the presentation information is intended for a second subset of readers, the first and second subsets of readers being disjoint.

14. The system of claim 13, wherein the first subset of readers has an affinity with the second subset of readers.

15. The system of claim 11, wherein the display module is further configured to receive the presentation information from the recommendation subsystem.

16. A computer system for processing comments corresponding to a plurality of portions of an electronic book, the system comprising:
a processor;
an aggregation module configured to receive a plurality of comments from a plurality of users, each comment corresponding to one of the plurality of portions, and to group the comments responsive to characteristics of the users;
an analysis module configured to interact with the processor to generate reader-specific comments corresponding to each of the plurality of portions, based on the comments as grouped by the aggregation module; and
a presentation module configured to generate presentation information for presentation at a client device based on reader-specific comments.

17. The system of claim 16, wherein the presentation information includes an indicator of usefulness of a particular one of the plurality of portions to a specific reader.

18. The system of claim 17, wherein the indicator corresponds to an affinity shared by the specific reader and a subset of the plurality of users.

19. The system of claim 17, wherein the indicator is a recommendation shared on a social network.

20. The system of claim 17, wherein the indicator is generated responsive to a correlation between comments, created by the specific reader, corresponding to a plurality of references and comments, created by a subset of the plurality of users, corresponding to the plurality of references, the electronic book not being one of the plurality of references.
